(19) United States
(12) Patent Application Publication
(10) Pub. No.: US 2011/0033814 A1
(43) Pub. Date: Feb. 10, 2011

(54) Trisectional Arch Wire

(76) Inventor: Arthur L. WOOL, Wyomissing, PA (US)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/848,266

(22) Filed: Aug. 2, 2010

Related U.S. Application Data
(60) Provisional application No. 61/231,058, filed on Aug. 4, 2009.

(51) Int. Cl. A61C 7/26

(52) U.S. Cl. 433/20

(57) ABSTRACT

An orthodontic arch wire has a generally parabolic shape and includes a curved anterior segment and a pair of posterior segments connected to and extending from respective ends of the curved anterior segment. The curved anterior segment has a circular cross-section and does not have substantially the same flexural rigidity as the pair of posterior segments, at least one of which has a non-circular cross-section. The three pieces are joined together to form the generally parabolic shape.

### CROSS-REFERENCE TO RELATED APPLICATION

This application is a nonprovisional application of U.S. Provisional Application Ser. No. 61/231,058, filed Aug. 4, 2009, the contents of which are incorporated herein by reference.

### BACKGROUND OF THE INVENTION

The present invention relates to an orthodontic arch wire.

A variety of malocclusions are corrected by the use of orthodontic arch wires. In corrections using arch wires, brackets are secured to the patient's teeth and, in each of a number of stages during the course of treatment, an arch wire is secured in the brackets. As treatment progresses, the arch wire which is used more closely approaches the ideal arch form. The arch wires progressively correct misalignments of the patient's teeth.

It is known in the art to use an arch wire of non-circular cross-section, e.g., rectangular or trapezoidal, in brackets with rectangular slots so that the arch wire cannot rotate in the slot and that torque can be applied to the teeth by the arch wire through the brackets. One problem with the use of non-circular cross-sectional arch wires is that the arch wire tends to bind in the brackets on the posterior teeth as a result of excessive friction. It is known from my prior U.S. Pat. No. 4,424,033, the contents of which are incorporated by reference herein in their entireties, to use an arch wire having posterior segments of circular cross-section and an anterior segment, at least a part of which is rectangular or trapezoidal in cross-section. The arch wire described in my prior U.S. Pat. No. 4,424,033 has a unitary construction, i.e., is formed from a single or unitary length of wire. Manufacture of such a wire has proved difficult in that it is generally necessary to start with an arch wire of non-circular, e.g., rectangular or trapezoidal, cross-section, and work the posterior segments of the wire to provide a circular cross-section.

Applicant's U.S. Pat. No. 6,811,397, issued Nov. 2, 2004, and entitled “Three segment orthodontic arch wire having uniform flexural rigidity,” the contents of which are incorporated by reference herein in their entireties, discloses an arch wire including a curved anterior segment and a pair of posterior segments connected to and extending from respective ends of the curved anterior segment, in which the curved anterior segment and the pair of posterior segments comprise three discrete pieces having substantially the same flexural rigidity.

### SUMMARY OF THE INVENTION

The present invention concerns an orthodontic arch wire that has a generally parabolic shape. The arch wire includes a curved anterior segment and a pair of posterior segments connected to and extending from respective ends of the curved anterior segment. The curved anterior segment has a circular cross-section and does not have substantially the same flexural rigidity as the pair of posterior segments, at least one of which has a non-circular cross-section. The three pieces are joined together to form the generally parabolic shape.

### BRIEF DESCRIPTION OF THE DRAWINGS

FIG. 1 is a plan view of the orthodontic arch wire of the present invention.

FIG. 2 is an exploded perspective view of one embodiment of the arch wire of the present invention.

FIG. 3 perspective view of a variant of the tube which can be used to join the segments of the arch wire of the present invention.

### DETAILED DESCRIPTION OF THE INVENTION

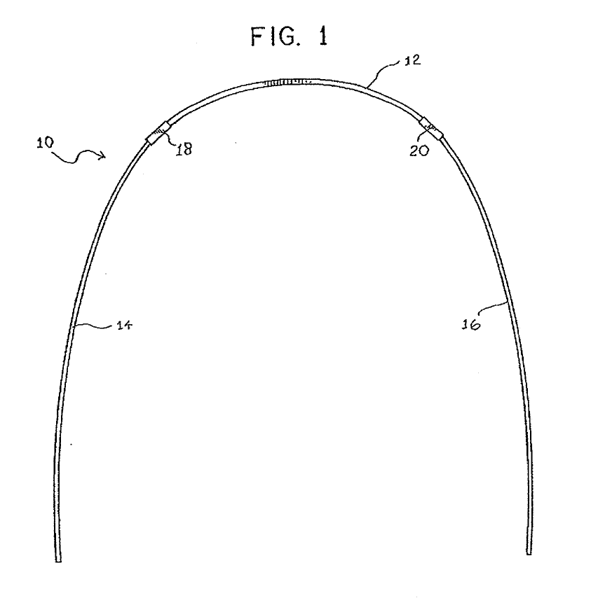

FIG. 1 is a plan view of the orthodontic arch wire of the present invention. As can be seen in FIG. 1, the orthodontic arch wire, generally designated by the reference numeral 10, has a generally parabolic shape. The arch wire 10 includes a curved anterior segment 12 and a pair of posterior segments 14, 16 connected to and extending from the respective ends of the curved anterior segment 12. In the embodiment shown in FIG. 1, the three pieces, i.e., the anterior segment 12 and the pair of posterior segments 14, 16, are joined together to form the generally parabolic shape by tubes 18, 20, respectively, as described more fully in applicant's U.S. Pat. No. 6,811,397.

The curved anterior segment 12 does not have substantially the same flexural rigidity as the pair of posterior segments 14, 16. The term “flexural rigidity” is used herein in the same manner as in U.S. Pat. No. 4,412,819 to Cannon, the contents of which are incorporated by reference herein in their entireties, i.e., in a conventional sense as defined by Young's modulus of the segment times the second moment of inertia of the segment cross-section. By the term “substantially the same” applicant generally means flexural rigidity which is either identical or varies only to a small extent.

While the tube 20 is shown to have a square cross-sectional shape, the tube can have an oval, round or rectangular cross-sectional shape. Depending on the metal used for the arch wire 10, the respective ends may also be directly soldered or welded without the use of the tube 20.

The anterior segment 12 has a circular cross-section while at least one of the posterior segments 14, 16 has a non-circular cross-section. In the embodiment shown in FIG. 2, the posterior segment 16 has a rectangular, e.g., square, cross-section, although other non-circular cross-sections, e.g., trapezoidal, may be used. This is useful to apply torque to the posterior teeth without applying it to the anterior teeth. In this embodiment, either or both of the posterior segments may have a non-circular cross-section. Thus, the arch of the present invention is beneficial, if during orthodontic treatment, the posterior segments are expanded resulting in a tipping of the posterior dentition. The torque movements induced by the aforementioned non-circular posterior segments 14, 16 would be able to correct the tipping of the posterior dentition and result in improvement of the cuspal interdigitation of the posterior occlusion.

The posterior segment 14, 16 of the arch wire 10 that has the non-circular cross-section can have torque built into it either uniformly over its length or torque which varies over its length or can be non-torqued. Providing built-in torque is described in U.S. Pat. No. 5,722,827 to Allesee et al and U.S. Pat. No. 6,036,489 to Brosius, the contents of both of which are incorporated herein by reference in their entireties. Both torqued and non torqued posterior segments would encourage axial inclination movements in the posterior segments due to the arch slots and buccal tubes being of rectangular interior dimensions if the slots and the tube interiors are not in alignment with the posterior non torqued wire segments. Increased torque movements would be induced if there is torque introduced as a supplemental measure to the non circular posterior arch sections.

Whatever torque action is introduced in either posterior segment 14, 16 would not interfere with the axial inclination of the anterior dentition as the twist introduced by the torque application would result in spinning movements in the circular anterior segment 12. That is, torque action is introduced by the posterior non-circular segments 14, 16 fitting into non-circular posterior bracket slots and this torque action twists the arch in its entirety, introducing torque motion to the posterior dentition; however, the anterior brackets, and therefore the anterior dentition, are spared from this torque action by the circular anterior segment 12.

It may be desirable for reasons of aesthetics or other reasons, e.g., to lower friction, to plate the arch wire 10 with a metal layer, e.g., a noble metal layer, e.g., gold.

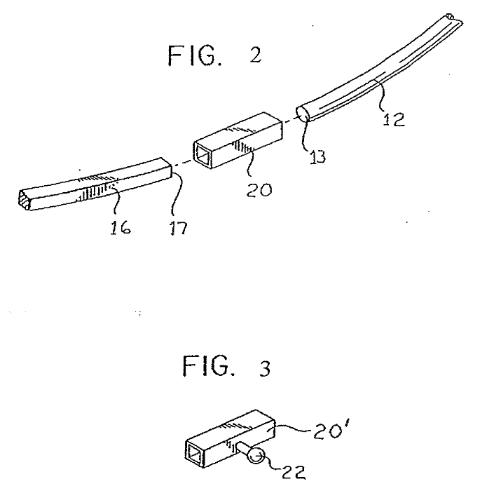

Either or both the tubes can be provided with an attachment device for various auxiliaries such as elastomerics, elastics, coiled springs, etc. For example, as shown in FIG. 3, a tube 20′ is provided with a post or hook 22.

The anterior segment 12 and the posterior segments 14, 16 may be of similar or different alloys, but the curved anterior segment 12 does not have substantially the same flexural rigidity as the pair of posterior segments 14, 16. The posterior segments 14, 16 would benefit from a more resilient alloy such as beta or nickel titanium, although Elgiloy (nickel-chrome-cobalt) and stainless steel could be used. The anterior segment 12 would preferably be of stiffer alloys such as Elgiloy or stainless steel.

As will be apparent to those skilled in the art, various modifications of the disclosed embodiments could be made without departing from the teachings of the present invention.

I claim:

1. An orthodontic arch wire having a generally parabolic shape, comprising a curved anterior segment and a pair of posterior segments connected to and extending from respective ends of the curved anterior segment, wherein the curved anterior segment and the pair of posterior segments comprise three discrete pieces, the curved anterior segment having a circular cross-section, at least one of the posterior segments having a non-circular cross-section, the curved anterior segment not having substantially the same flexural rigidity as the pair of posterior segments, and the curved anterior segment and the pair of posterior segments being joined together to form the generally parabolic shape.

2. The orthodontic arch wire according to claim 1, wherein each of the pair of posterior segments is connected to one of the respective ends of the curved anterior segment by a tube into which a mating end of the posterior segment and the mating one of the respective ends of the curved anterior segment are inserted and held.

3. The orthodontic arch wire according to claim 2, wherein the mating end of the posterior segment and the mating one of the respective ends of the curved anterior segment are held in each tube by at least one of crimping the tube, swaging the tube, brazing the ends to the tube, soldering the ends to the tube and welding the ends to the tube.

4. The orthodontic arch wire according to claim 2, further comprising a post or hook connected to the tube.

5. The orthodontic arch wire according to claim 1, wherein each of the pair of posterior segments has a non-circular cross-sectional shape.

6. The orthodontic arch wire according to claim 5, wherein each of the posterior segments has a rectangular or trapezoidal cross-sectional shape.

7. The orthodontic arch wire according to claim 5, wherein each of the posterior segments has built-in uniform torque over its length.

8. The orthodontic arch wire according to claim 5, wherein each of the posterior segments has built-in torque that varies over its length.

9. The orthodontic arch wire according to claim 1, wherein the posterior segments are made of a material that is more resilient than the material of which the anterior segment is made.

10. The orthodontic arch wire according to claim 9, wherein the posterior segments are made of a material selected from the group consisting of beta titanium, nickel titanium, Elgiloy and stainless steel.

11. The orthodontic arch wire according to claim 10, wherein the anterior segment is made of a material selected from the group consisting of Elgiloy and stainless steel.

12. The orthodontic arch wire according to claim 9, wherein the anterior segment is made of a material selected from the group consisting of Elgiloy and stainless steel.
